(19) United States
(12) Patent Application Publication
(10) Pub. No.: US 2006/0024536 A1
(43) Pub. Date: Feb. 2, 2006

(54) Fuel cell system

(75) Inventors: Hiroki Kabumoto, Saitama-City (JP); Takeshi Minamiura, Ora-Gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/191,955

(22) Filed: Jul. 29, 2005

(30) Foreign Application Priority Data
Jul. 30, 2004 (JP) 2004-224571

(51) Int. Cl. H01M 8/00

(52) U.S. Cl. 429/12

(57) ABSTRACT

A fuel cell stack has a built-in sensor MEA including: a sensor ion exchange membrane; an anode to which part of fuel supplied to the fuel cell stack flows in, the anode being arranged on one side of the sensor ion exchange membrane; and a cathode from which the part of the fuel supplied to the fuel cell stack flows out, the cathode being arranged on the other side of the sensor ion exchange membrane. An external power supply applies a predetermined potential difference to between the anode and the cathode. A current occurring from electrolysis of the fuel is measured by using an ammeter.

### BACKGROUND OF THE INVENTION

1. Field of the Invention

The invention relates to a fuel cell. More particularly, the invention relates to the technology of detecting the state of a fuel fed to the fuel cell.

2. Description of the Related Art

Fuel cells are devices for generating electric energy from fuel and an oxidant, and are capable of providing high generation efficiency. One of the chief features of the fuel cells is direct power generation without the process of thermal energy or kinetic energy as in conventional generation methods. High generation efficiency can thus be expected from fuel cells of even smaller scales. Besides, low emission of nitrogen compounds and the like, as well as low noise and low vibrations, yield improved environmental friendliness. As above, since the fuel cells can utilize the chemical energy of the fuel effectively and have the feature of environmental friendliness, they are expected as energy supply systems to bear the 21st century. In various applications ranging from large-scale power generation to small-scale power generation, including space technologies, automobiles, and portable devices, the fuel cells are attracting attention as promising novel generation systems. Technological development toward practical use has thus been made in earnest.

Among various forms of fuel cells, a direct methanol fuel cell (DMFC) is recently gaining attention in particular. In the DMFC, methanol, the fuel, is fed directly to the anode without any modification so that electric power is generated through the electrochemical reaction between methanol and oxygen. As compared to hydrogen, methanol provides higher energy per unit volume, is well-suited to storage, and has low risk of explosion or the like. Applications such as the power supplies of automobiles and cellular phones are thus expected.

When the anode of the DMFC is fed with a methanol aqueous solution that has too high a concentration, degradation of the ion exchange membrane inside the DMFC is accelerated with a drop in reliability. There can also occur so-called cross leak, or the phenomenon that part of the methanol aqueous solution fed to the anode is not consumed for power generation but is transmitted through the ion exchange membrane to reach the cathode. On the other hand, if the concentration of the methanol aqueous solution is too low, the DMFC cannot provide sufficient output. For this reason, the methanol aqueous solution to be fed to the anode of the DMFC is preferably adjusted to 0.5 to 4 mol/L, or desirably 0.8 to 1.5 mol/L, in concentration. It is also known that this range of concentrations can be narrowed for the sake of stable operation of the DMFC.

Now, take the case of a system having a DMFC. For the sake of operating the DMFC for a long period and reducing the size and weight of the system as well, the system is typically provided with a tank for containing high-concentration methanol of 20 mol/L or above. In this method, the methanol must be thinned and adjusted in concentration before fed to the anode of the DMFC. Then, in order to adjust the concentration of the methanol aqueous solution to 0.5 to 1.5 mol/L inside the system, various types of methanol aqueous solution concentration sensors, including optical type, supersonic type, and specific-gravity type, have been used to measure the methanol aqueous solution for concentration.

For example, Japanese Patent Laid-Open Publication No. 2004-095376 has disclosed the technique of installing a methanol sensor on a circulation path of the methanol aqueous solution at a location where a relatively smaller amount of carbon dioxide gas exists.

Nevertheless, if the concentration of the methanol aqueous solution to be fed to the anode is detected by using a methanol aqueous solution concentration sensor as heretofore, there can occur the following problems.

That is, when a methanol aqueous solution concentration sensor is installed inside the fuel cell system, system miniaturization becomes difficult. The operation of the methanol aqueous solution concentration sensor also consumes electric power, and thus requires extra power. Moreover, expenses necessary for the methanol aqueous solution concentration sensor push up the cost.

In addition, the conventional methanol aqueous solution concentration sensors are susceptible to external factors such as temperature changes and load fluctuations during the operation of the methanol fuel cell, and the occurrence of by-products. This means that the concentration measurements are not always accurate.

### SUMMARY OF THE INVENTION

The present invention has been achieved in view of the foregoing problems. It is thus an object of the present invention to provide a technology for evaluating the concentration of the fuel fed to the fuel cell appropriately.

A fuel cell system according to the present invention comprises a fuel concentration sensor including: a sensor anode to which part of fuel fed to a fuel cell stack flows in; a sensor cathode from which the part of the fuel flows out; an ion exchange membrane interposed between the sensor anode and the sensor cathode; an external power supply which applies a potential difference to between the sensor anode and the sensor cathode; and a current measuring unit which measures a current occurring from electrolysis of the part of the fuel. Consequently, it is possible to evaluate the concentration of the fuel fed to the fuel cell stack while suppressing external factors to a minimum.

In the foregoing configuration, the fuel concentration sensor may be built in the fuel cell stack. This allows compact configuration of the fuel cell system.

In the foregoing configuration, the fuel concentration sensor may have an electrode area smaller than that of a cell constituting the fuel cell stack. This makes it possible to suppress the amount of fuel to be consumed by the fuel concentration sensor.

In the foregoing configuration, the sensor anode and the sensor cathode may contain smaller amounts of catalysts than the amounts of those contained in a generation anode and a generation cathode constituting the cell, respectively. This makes it possible to suppress the amount of fuel to be consumed by the fuel concentration sensor.

The foregoing configuration may also comprise: a fuel reservoir unit which reserves the fuel to be fed to the fuel cell stack; a fuel supply unit which supplies the fuel to the fuel reservoir unit; a fuel feed unit which feeds the fuel from the fuel reservoir unit to a generation anode of the fuel cell; an oxidant feed unit which feeds an oxidant to a generation cathode of the fuel cell; and a control unit which adjusts the supply of the fuel by the fuel supply unit. The control unit may supply the fuel to the fuel reservoir unit when the current value measured by the current measuring unit falls below a reference value. Consequently, it is possible to maintain the fuel cell in an appropriate state of generation. In the foregoing configuration, the fuel may be a methanol aqueous solution.

Incidentally, any appropriate combinations of the foregoing components are also intended to fall within the scope of the invention covered by a patent to be claimed by this patent application.

### BRIEF DESCRIPTION OF THE DRAWINGS

FIG. 1 is a diagram showing the overall configuration of a fuel cell system according to an embodiment of the present invention;

FIG. 2 is a diagram showing the configuration of a fuel cell stack for use in the present embodiment;

FIG. 3 is a diagram showing the configuration of a cell;

FIG. 4 is a sectional view of a generation MEA;

FIG. 5 is a diagram showing the configuration of a fuel concentration sensor;

FIG. 6 is a sectional view of a sensor MEA of the fuel concentration sensor; and

FIG. 7 is a flowchart showing the operation for managing the methanol aqueous solution in the fuel cell system.

### DETAILED DESCRIPTION OF THE INVENTION

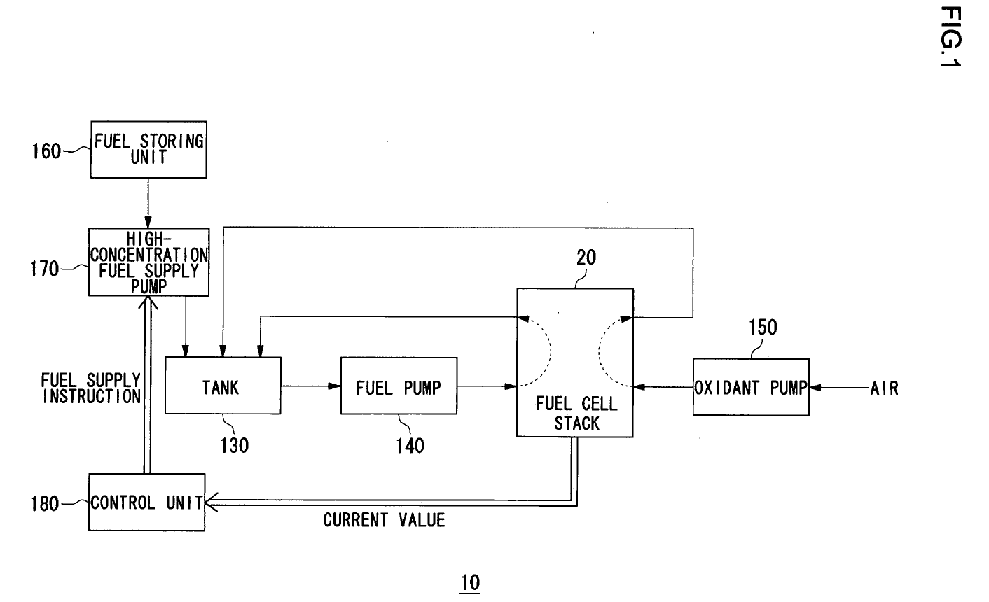

Hereinafter, an embodiment of the present invention will be described with reference to the drawings. FIG. 1 shows the overall configuration of a fuel cell system 10 according to the embodiment of the present invention. The fuel cell system 10 comprises a fuel cell stack 20, a tank 130, a fuel pump 140, an oxidant pump 150, a fuel storing unit 160, a high-concentration fuel supply pump 170, and a control unit 180.

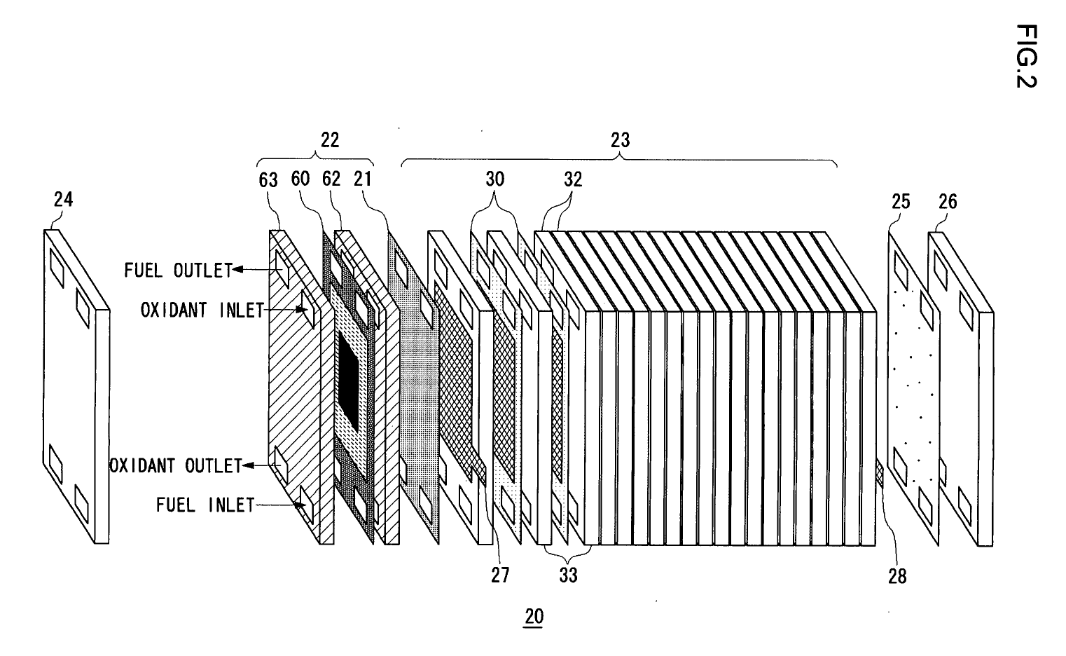

The fuel cell stack 20 generates electric power through electrochemical reaction by using a methanol solution and air. FIG. 2 shows the configuration of the fuel cell stack 20 for use in the present embodiment. The fuel cell stack 20 has a fuel concentration sensor 22 and a generation stack 23 which are arranged with an insulator 21 interposed therebetween. An end plate 24 is arranged outside the fuel concentration sensor 22. An end plate 26 is arranged outside the generation stack 23 via an insulator 25. The end plates 24 and 26 fasten the laminate consisting of the fuel concentration sensor 22, the insulator 21, the generation stack 23, and the insulator 25. Building the fuel concentration sensor 22 into the fuel cell stack 20 thus allows compact configuration of the fuel cell system.

The generation stack 23 has generation membrane electrode assemblies (hereinafter, referred to as generation MEAs) 30 and bipolar plates 32 which are laminated alternately between current collectors 27 and 28. Cells 33 are composed of a generation MEA 30 and a pair of bipolar plates 32 each.

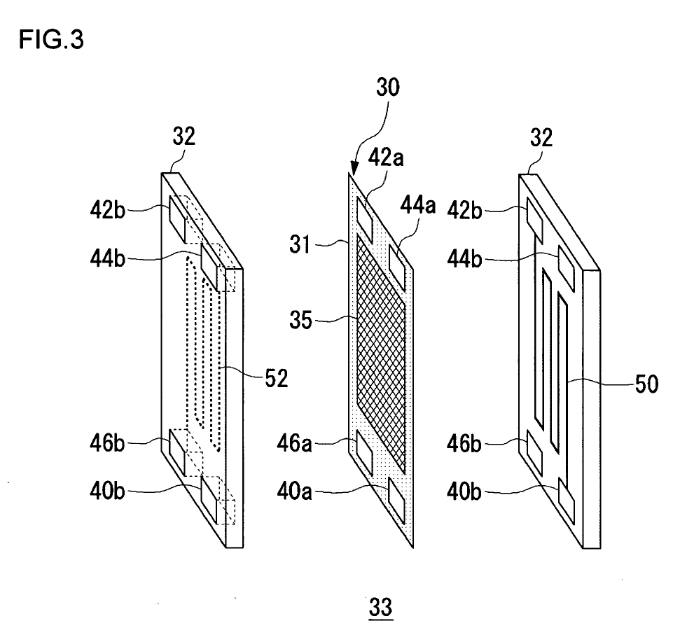

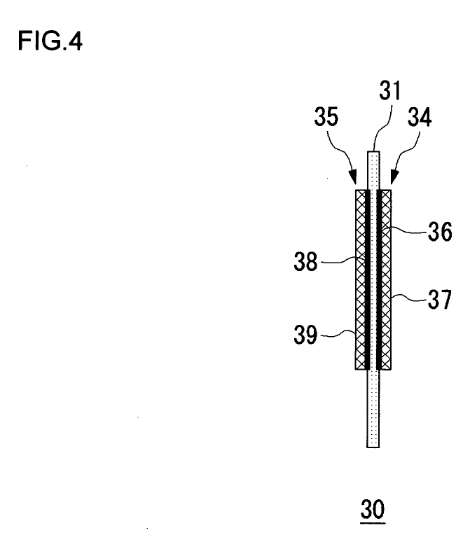

FIG. 3 shows the configuration of a cell 33. FIG. 4 shows a sectional view of the generation MEA 30. The generation MEA 30 has an ion exchange membrane 31, an anode 34, and a cathode 35. The ion exchange membrane 31 is made of Nafion 115, for example. The ion exchange membrane 31 has a fuel inlet manifold 40a, a fuel outlet manifold 42a, an oxidant inlet manifold 44a, and an oxidant outlet manifold 46a.

The anode 34 is formed on one side of the ion exchange membrane 31. The anode 34 includes a catalyst layer 36 in contact with the ion exchange membrane 31, and a fuel diffusion layer 37 formed on the catalyst layer 36. The catalyst layer 36 is made of a carbon supported platinum-ruthenium alloy catalyst, for example.

Meanwhile, the cathode 35 is formed on the other side of the ion exchange membrane 31. The cathode 35 includes a catalyst layer 38 in contact with the ion exchange membrane 31, and a fuel diffusion layer 39 formed on the catalyst layer 38. The catalyst layer 36 is made of a carbon supported platinum catalyst, for example.

Each of the bipolar plates 32 has a fuel channel 50 and an oxidant channel 52. The fuel channel 50 is formed in the side to face the anode 34 of the generation MEA 30, and the oxidant channel 52 is formed in the side to face the cathode 35 of the generation MEA 30. In FIG. 3, the bipolar plate 32 to make contact with the anode 34 of the generation MEA 30 is shown with its oxidant channel omitted. The bipolar plate 32 to make contact with the cathode 35 of the generation MEA 30 is shown with its fuel channel omitted. Each bipolar plate 32 has a fuel inlet manifold 40b, a fuel outlet manifold 42b, an oxidant inlet manifold 44b, and an oxidant outlet manifold 46b. The fuel channel 50 establishes communication between the fuel inlet manifold 40b and the fuel outlet manifold 42b. The oxidant channel 52 establishes communication between the oxidant inlet manifold 44b and the oxidant outlet manifold 46b.

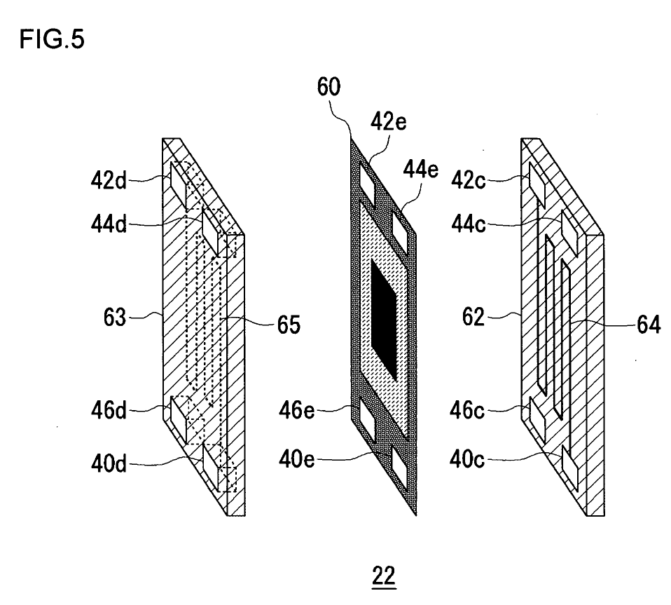

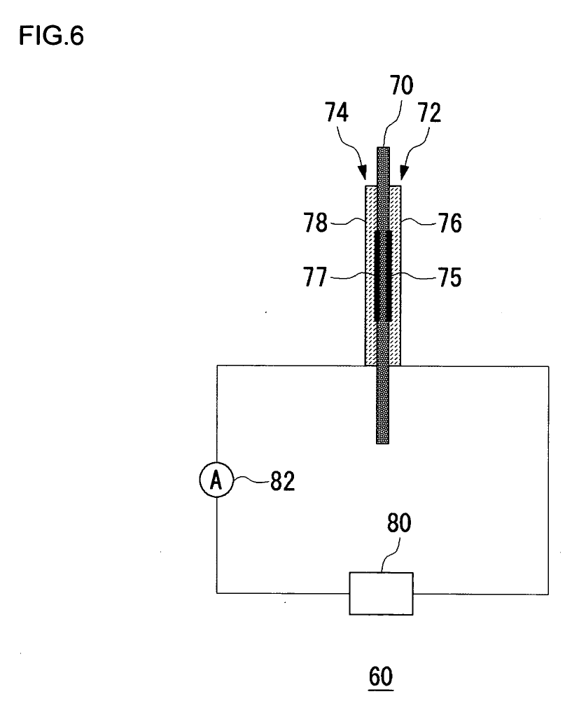

FIG. 5 shows the configuration of the fuel concentration sensor 22. FIG. 6 shows a sectional view of a sensor MEA 60 of the fuel concentration sensor 22.

The fuel concentration sensor 22 is insulated from the generation stack 23 by the insulator 21. The fuel concentration sensor 22 is configured so that a sensor MEA 60 is interposed between two fuel plates 62 and 63.

The fuel plate 62 is arranged on the anode side of the sensor MEA 60. The fuel plate 62 is provided with a fuel channel 64. The fuel plate 62 also has a fuel inlet manifold 40c, a fuel outlet manifold 42c, an oxidant inlet manifold 44c, and an oxidant outlet manifold 46c. The fuel channel 64 establishes communication between the fuel inlet manifold 40c and the fuel outlet manifold 42c.

Meanwhile, the fuel plate 63 is arranged on the cathode side of the sensor MEA 60. The fuel plate 63 is provided with a fuel channel 65. The fuel plate 63 also has a fuel inlet manifold 40d, a fuel outlet manifold 42d, an oxidant inlet manifold 44d, and an oxidant outlet manifold 46d. The fuel channel 65 establishes communication between the fuel inlet manifold 40d and the fuel outlet manifold 42d. As a result, part of the fuel fed to the fuel cell stack 20 flows into the fuel channels 64 and 65.

It is desirable that the fuel channels 64 and 65 formed in the fuel plates 62 and 63, respectively, take the same courses as those of the fuel channels formed in the cells 33. Consequently, the fuel concentration sensor 22 and the cells 33 can be put in the same condition for fuel distribution.

The sensor MEA 60 has a sensor ion exchange membrane 70, an anode 72 in contact with one side of the sensor ion exchange membrane 70, and a cathode 74 in contact with the other side of the sensor ion exchange membrane 70.

The sensor ion exchange membrane 70 is made of Nafion 115, for example. The sensor ion exchange membrane 70 has a fuel inlet manifold 40e, a fuel outlet manifold 42e, an oxidant inlet manifold 44e, and an oxidant outlet manifold 46e.

The anode 72 is formed on one side of the sensor ion exchange membrane 70. The anode 72 includes a catalyst layer 75 in contact with the sensor ion exchange membrane 70, and a fuel diffusion layer 76 formed on the catalyst layer 75. The catalyst layer 75 is made of a carbon supported platinum-ruthenium alloy catalyst, for example.

Meanwhile, the cathode 74 is formed on the other side of the sensor ion exchange membrane 70. The cathode 74 includes a catalyst layer 77 in contact with the sensor ion exchange membrane 70, and a fuel diffusion layer 78 formed on the catalyst layer 77. The catalyst layer 77 is made of a carbon supported platinum catalyst, for example.

The catalyst layers 75 and 77 desirably have an area smaller than those of the catalyst layers 36 and 38 of the generation MEAs 30 described above. Since the electrode areas of the fuel concentration sensor 22 can thus be made smaller than the electrode areas of the cells 33, it is possible to suppress fuel consumption in the fuel concentration sensor 22 for the sake of energy saving. Incidentally, the fuel consumption in the fuel concentration sensor 22 can also be suppressed by making the amounts of catalysts contained in the catalyst layers 75 and 77 of the sensor MEA 60 smaller than the amounts of catalysts contained in the catalyst layers 36 and 38 of the generation MEAs 30.

An external power supply 80 applies a potential difference (for example, 0.5 V) higher than the electrolytic voltage of methanol to between the anode 72 and the cathode 74. An ammeter 82 measures the current that occurs from the electrolysis of methanol due to the potential difference. The current value measured by the ammeter 82 is transmitted to the control unit 180. If the potential difference given by the external power supply 80 is constant, the current occurring from the electrolysis of the fuel is in proportional to the fuel concentration. Monitoring the current value by the ammeter 82 thus allows appropriate evaluation of the fuel concentration. This also lessens the influence of external factors since the electrolysis of the fuel depends directly on the fuel concentration.

Returning to FIG. 1, the tank 130 reserves the methanol aqueous solution to be fed to the fuel cell stack 20. The methanol aqueous solution reserved in the tank 130 is adjusted to 0.5 to 1.5 mol/L before the fuel pump 140 feeds it to the anode 72 of the fuel concentration sensor 22, built in the fuel cell stack 20, and the anodes 34 of the cells 33. After the reaction in the fuel cell stack 20, remaining unreacted fuel is recovered into the tank 130. In this way, the methanol aqueous solution fed to the fuel cell stack 20 circulates through the circulation system including the fuel cell stack 20 and the tank 130. Meanwhile, the oxidant pump 150 introduces air from exterior, and feeds it to the cathodes 35 of the cells 33. Products of the methanol-air reaction, such as water, are recovered into the tank 130.

The fuel storing unit 160 stores a high-concentration methanol aqueous solution having a concentration higher than that of the methanol aqueous solution reserved in the tank 130. For example, when the methanol aqueous solution in the tank 130 has a concentration of 1 mol/L, the high-concentration methanol aqueous solution in the fuel storing unit 160 may have a concentration of 22 mol/L. The high-concentration fuel supply pump 170 supplies a predetermined amount of high-concentration methanol aqueous solution from the fuel storing unit 160 to the tank 130 under the instruction of the control unit 180 to be described later.

The control unit 180 controls the operation of the high-concentration fuel supply pump 170 based on the current value transmitted from the ammeter 82, thereby adjusting the amount of the high-concentration methanol aqueous solution to be supplied to the tank 130.

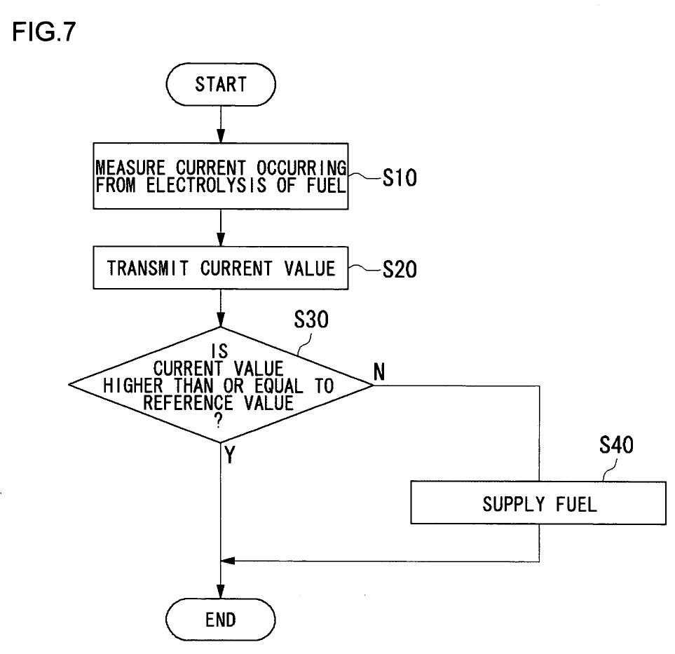

FIG. 7 is a flowchart showing the operation for managing the methanol aqueous solution in the fuel cell system 10. Initially, the ammeter 82 measures the current occurring from the electrolysis of the methanol aqueous solution (S10). The measured current value is transmitted to the control unit 180 (S20). The control unit 180 determines if the transmitted current value is higher than or equal to a predetermined reference value (S30). When the current value is higher than or equal to the predetermined reference value, this processing is terminated. On the other hand, if the current value falls below the predetermined reference value, the control unit 180 supplies the high-concentration methanol aqueous solution to the tank 130 by using the high-concentration fuel supply pump 170 (S40). Since the fuel concentration is thus evaluated based on the current value when the fuel supplied to the fuel cell stack 20 causes electrolysis, it is possible to suppress external factors to a minimum and estimate the fuel concentration more accurately. Moreover, since the fuel is supplied in accordance with the obtained current value, it is possible to maintain the fuel cell in an appropriate state of generation.

The present invention is not limited to the foregoing embodiment, and various modifications including design changes may be made thereto based on the knowledge of those skilled in the art. All such modified embodiments are also intended to fall within the scope of the present invention.

For example, the foregoing embodiment has dealt with the case where the fuel concentration sensor 22 is built in the fuel cell stack 20. The fuel concentration sensor 22 may be formed as a member separate from the fuel cell stack 20, however, so that the fuel concentration sensor 22 is arranged on piping for feeding the fuel to the fuel cell stack 20.

What is claimed is:

1. A fuel cell system comprising a fuel concentration sensor including:
a sensor anode to which part of fuel fed to a fuel cell stack flows in;
a sensor cathode from which the part of the fuel flows out;
an ion exchange membrane interposed between the sensor anode and the sensor cathode;
an external power supply which applies a potential difference to between the sensor anode and the sensor cathode; and
a current measuring unit which measures a current occurring from electrolysis of the part of the fuel.

2. The fuel cell system according to claim 1, wherein the fuel concentration sensor is built in the fuel cell stack.

3. The fuel cell system according to claim 1, wherein the fuel concentration sensor has an electrode area smaller than that of a cell constituting the fuel cell stack.

4. The fuel cell system according to claim 2, wherein the fuel concentration sensor has an electrode area smaller than that of a cell constituting the fuel cell stack.

5. The fuel cell system according to claim 1, wherein the sensor anode and the sensor cathode contain smaller amounts of catalysts than the amounts of those contained in a generation anode and a generation cathode constituting the cell, respectively.

6. The fuel cell system according to claim 2, wherein the sensor anode and the sensor cathode contain smaller amounts of catalysts than the amounts of those contained in a generation anode and a generation cathode constituting the cell, respectively.

7. The fuel cell system according to claim 3, wherein the sensor anode and the sensor cathode contain smaller amounts of catalysts than the amounts of those contained in a generation anode and a generation cathode constituting the cell, respectively.

8. The fuel cell system according to claim 4, wherein the sensor anode and the sensor cathode contain smaller amounts of catalysts than the amounts of those contained in a generation anode and a generation cathode constituting the cell, respectively.

9. The fuel cell system according to claim 1, further comprising:
a fuel reservoir unit which reserves the fuel to be fed to the fuel cell stack;
a fuel supply unit which supplies the fuel to the fuel reservoir unit;
a fuel feed unit which feeds the fuel from the fuel reservoir unit to a generation anode of the fuel cell;
an oxidant feed unit which feeds an oxidant to a generation cathode of the fuel cell; and
a control unit which adjusts the supply of the fuel by the fuel supply unit, and wherein
the control unit supplies the fuel to the fuel reservoir unit when the current value measured by the current measuring unit falls below a reference value.

10. The fuel cell system according to claim 2, further comprising:
a fuel reservoir unit which reserves the fuel to be fed to the fuel cell stack;
a fuel supply unit which supplies the fuel to the fuel reservoir unit;
a fuel feed unit which feeds the fuel from the fuel reservoir unit to a generation anode of the fuel cell;
an oxidant feed unit which feeds an oxidant to a generation cathode of the fuel cell; and
a control unit which adjusts the supply of the fuel by the fuel supply unit, and wherein
the control unit supplies the fuel to the fuel reservoir unit when the current value measured by the current measuring unit falls below a reference value.

11. The fuel cell system according to claim 2, further comprising:
a fuel reservoir unit which reserves the fuel to be fed to the fuel cell stack;
a fuel supply unit which supplies the fuel to the fuel reservoir unit;
a fuel feed unit which feeds the fuel from the fuel reservoir unit to a generation anode of the fuel cell;
an oxidant feed unit which feeds an oxidant to a generation cathode of the fuel cell; and
a control unit which adjusts the supply of the fuel by the fuel supply unit, and wherein
the control unit supplies the fuel to the fuel reservoir unit when the current value measured by the current measuring unit falls below a reference value.

12. The fuel cell system according to claim 4, further comprising:
a fuel reservoir unit which reserves the fuel to be fed to the fuel cell stack;
a fuel supply unit which supplies the fuel to the fuel reservoir unit;
a fuel feed unit which feeds the fuel from the fuel reservoir unit to a generation anode of the fuel cell;
an oxidant feed unit which feeds an oxidant to a generation cathode of the fuel cell; and
a control unit which adjusts the supply of the fuel by the fuel supply unit, and wherein
the control unit supplies the fuel to the fuel reservoir unit when the current value measured by the current measuring unit falls below a reference value.

13. The fuel cell system according to claim 5, further comprising:
a fuel reservoir unit which reserves the fuel to be fed to the fuel cell stack;
a fuel supply unit which supplies the fuel to the fuel reservoir unit;
a fuel feed unit which feeds the fuel from the fuel reservoir unit to a generation anode of the fuel cell;
an oxidant feed unit which feeds an oxidant to a generation cathode of the fuel cell; and
a control unit which adjusts the supply of the fuel by the fuel supply unit, and wherein
the control unit supplies the fuel to the fuel reservoir unit when the current value measured by the current measuring unit falls below a reference value.

14. The fuel cell system according to claim 1, wherein the fuel is a methanol aqueous solution.

15. The fuel cell system according to claim 2, wherein the fuel is a methanol aqueous solution.

16. The fuel cell system according to claim 3, wherein the fuel is a methanol aqueous solution.

17. The fuel cell system according to claim 4, wherein the fuel is a methanol aqueous solution.

18. The fuel cell system according to claim 5, wherein the fuel is a methanol aqueous solution.

19. The fuel cell system according to claim 9, wherein the fuel is a methanol aqueous solution.

20. The fuel cell system according to claim 10, wherein the fuel is a methanol aqueous solution.
